(19) United States
(12) Patent Application Publication
(10) Pub. No.: US 2003/0110306 A1
(43) Pub. Date: Jun. 12, 2003

(54) Method and system for use of a field programmable gate array (FPGA) cell for controlling access to on-chip functions of a system on a chip (SOC) integrated circuit

(75) Inventors: Robert Thomas Bailis, Cary, NC (US); Charles Edward Kuhlmann, Raleigh, NC (US); Charles Steven Lingafelt, Durham, NC (US); Ann Marie Rincon, Burlington, VT (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/015,921

(22) Filed: Dec. 10, 2001

(51) Int. Cl. G06F 15/16; G06F 9/00

(52) U.S. Cl. 709/253; 709/100

(57) ABSTRACT

A system on a chip (SOC) integrated circuit is disclosed. The SOC integrated circuit includes a plurality of logic functions. The logic functions include a plurality of base functions and a plurality of peripheral functions. The SOC integrated circuit includes at least one field programmable gate array (FPGA) cell that is coupled to the plurality of peripheral functions. The FPGA cell can then be configured to selectively enable the plurality of peripheral functions. Accordingly, one or more FPGA cells are provided on an SOC. The FPGA cells can then be selectively configured to enable one or more peripheral chip functions. Because FPGAs are customized “in the field”, i.e., in a specific customer application, one SOC part number containing all peripheral functions can be used to satisfy multiple customer markets.

Access Internal Signals for External Observation and Control;” Ser. No. ______ (RPS920010129US1), entitled “Method and System for Use of a Field Programmable Interconnect Within an ASIC for Configuring the ASIC;” Ser. No. ______ (RPS920010130US1), entitled “Method and System for Use of a Field Programmable Function Within a Chip to Enable Configurable I/O Signal Timing Characteristics; and” Ser. No. ______ (RPS920010131US1), entitled “Method and System for Use of a Field Programmable Function Within a Standard Cell Chip for Repair of Logic Circuits;” assigned to the assignee of the present application, and filed on the same date.

### FIELD OF THE INVENTION

The present invention relates generally to system on a chip (SOC) integrated circuit and more particularly to the use of an FPGA cell for controlling access to on-chip functions of such an integrated circuit.

### BACKGROUND OF THE INVENTION

Today a single system-on-a-chip (SOC) design can contain many diverse functions targeted for multiple markets. Often, a percentage of the chip's function (hereafter called the “base” function) is required for use in all applications, while other functions (hereafter called “peripheral” functions) are used by some customers and not by others. There are advantages and disadvantages to manufacturing and selling one chip that contains all functions to all customers regardless of the functions an individual customer uses, over creating multiple SOC part numbers that include only the functions a particular customer uses.

The advantages include:

Reduces design expense—designing and verifying one part is less expensive than designing multiple parts.

Reduces overall time-to-market. A single part can be designed, verified and manufactured faster than multiple designs each containing subsets of the total function.

Reduces part cost—one large volume part number usually results in a lower cost per die than manufacturing small volumes of multiple part numbers.

The disadvantages include:

difficult to charge customers for use of function(s) over the base function of the SOC.

difficult to both “hide” and prevent use of function(s) on the SOC and provide easy access to that function when desired or required.

Enabling and disabling access to function(s) on a chip can be controlled today through software methods, e.g., providing a customer a password required to bring up code that controls a given function, or information on software procedures required to initialize a peripheral device. In this case an SOC provider could provide passwords and/or initialization information for specific peripheral functions a customer requests and charge accordingly. Unfortunately software protection mechanism can be defeated by software hackers and function can be used without any payment to the SOC provider.

Others have attempted to control access of specific functions using software. This protection mechanism is vulnerable to being breached by software hackers. If a hacker does successfully defeat the software protection mechanism it is more likely than not that it would go undetected by the chip developer who does not ordinarily have access to his customer's computing environment.

Another method of controlling access is to manufacture different, unique die, each containing only the functions that the consumer has paid for and is allowed to use. This is far more costly than manufacturing high volumes of a single part number that can be personalized in the field, requires more design effort and has a longer lead line to produce multiple chips.

A secure method for controlling access to internal functions on an SOC is needed. The present invention addresses such a need.

### SUMMARY OF THE INVENTION

A system on a chip (SOC) integrated circuit is disclosed. The SOC integrated circuit includes a plurality of logic functions. The logic functions include a plurality of base functions and a plurality of peripheral functions. The SOC integrated circuit includes at least one field programmable gate array (FPGA) cell that is coupled to the plurality of peripheral functions. The FPGA cell can then be configured to selectively enable the plurality of peripheral functions.

Accordingly, one or more FPGA cells are provided on an SOC. The FPGA cells can then be selectively configured to enable one or more peripheral chip functions. Because FPGAs are customized “in the field”, i.e., in a specific customer application, one SOC part number containing all peripheral functions can be used to satisfy multiple customer markets.

### BRIEF DESCRIPTION OF THE DRAWINGS

FIG. 1 illustrates multiple potential uses of an FPGA cell to enable function on a typical SOC design.

FIG. 2 shows one embodiment using an on-chip register that indicates to the CPU whether a function is enabled.

### DETAILED DESCRIPTION

The present invention relates generally to system on a chip (SOC) integrated circuit and more particularly to the use of an FPGA for controlling access to on-chip functions of such an integrated circuit. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In a system and method in accordance with the present invention, a system on a chip (SOC) integrated circuit includes a plurality of logic functions, wherein the plurality of logic functions comprise a plurality of base functions and a plurality of peripheral functions. Accordingly, one or more FPGA cells are provided on an SOC. The FPGA cells can then be selectively configured to enable one or more peripheral chip functions. Because FPGAs are customized “in the field”, i.e., in a specific customer application, one SOC part number containing all peripheral functions can be used to satisfy multiple customer markets. An FPGA programming file would be developed by the SOC provider and shipped with the SOC part number in a companion ROM or shipped as a bit string that the customer uses to program a companion ROM. When the customer's system is powered up the ROM file personalizes the FPGA cell on the SOC, enabling the use of the specific peripheral functions the customer requested and paid for.

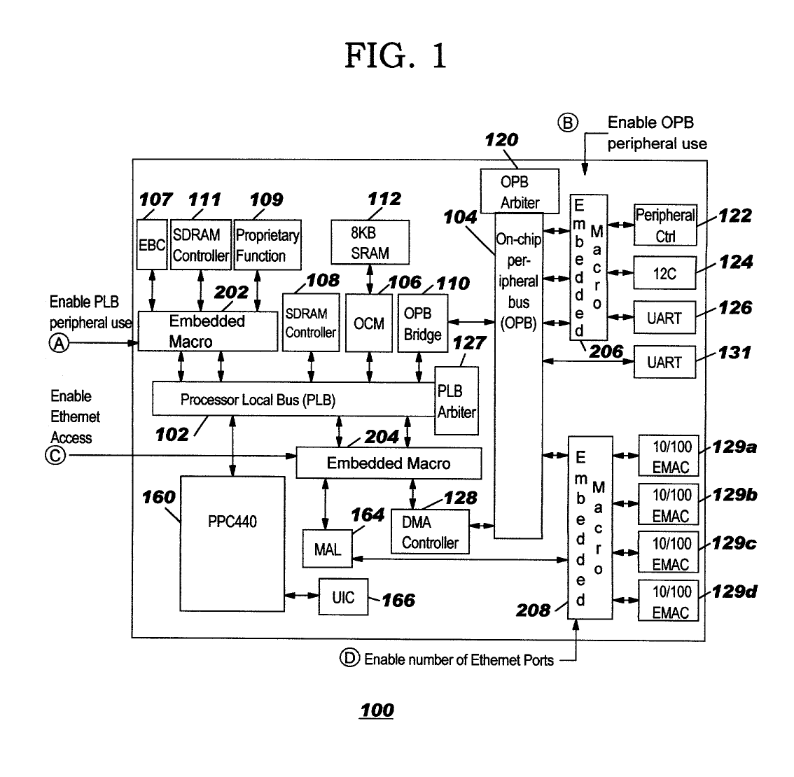

FIG. 1 illustrates network processor 100 that utilizes a plurality of field programmable gate array (FPGA) cells in accordance with the present invention. Although the present invention will be discussed in the context of utilizing an embedded FPGA cell in conjunction with a processor, one of ordinary skill in the art readily recognizes that the system and method in accordance with the present invention could be utilized in a variety of devices.

As is seen, the network processor 100 includes a processor local bus (PLB) 102, and an on-chip peripheral bus (OPB) 104. As is also seen, there are a plurality of functional blocks coupled to these busses 102 and 104. An on-chip memory controller (OCM) 106, an SDRAM controller 108 and OPB bridge 110 are all in communication with the PLB 102. An SRAM 112 is coupled to the OCM 106. The PLB 102 also includes a PLB arbitration unit 127.

The OPB bridge 110 is also in communication with an on-chip peripheral bus 104 that also includes an arbitration unit 120. A first UART 131 interacts directly with the OPB 104. There are a plurality of devices that interact with the on-chip peripheral bus (OPB) 104 via an FPGA cell 206. As is seen, they include a peripheral controller 122, a second UART 126, an I²C interface 124 and media access controller (MAC) 127. Another plurality of devices (multiple media access controller (MAC) devices 129a-d) interact with the OPB 104 and the Media access layer (MAL) via an FPGA cell 204. A DMA controller 128 is also coupled between the PLB 102 and OPB 104 via FPGA cell 208.

The PLB 102 also communicates with a microprocessor 160. In addition, a media access layer (MAL) function 164 is in communication with the Processor Local Bus 102 via an FPGA cell 204. An interrupt controller 166 communicates with the processor 160.

There are a plurality of FPGA cells 202, 204, 206 and 208 coupled between some of the functional blocks and the buses 102 and 104. FPGA cell 202 is coupled to bus 102 and to the external bus controller (EBC) 107, a second SDRAM controller 111 and a proprietary function 109. FPGA cell 204 is coupled to the PLB 102, the MAL function 164, and the DMA Controller 128. FPGA cell 206 is coupled to the peripheral controller 122, I²c 124 and a first UART 126. FPGA cell 208 is coupled to the plurality of media access controllers 129a-129d and the MAL 164. The FPGA cells 206 and 208 are also coupled to the OPB 104.

The base functions of the SOC 100 comprise the processor 160, UIC controller 166, SDRAM controller 108, OCM 106 and SRAM 112, PLB and OPB arbiters 127 and 120, an OPB bridge 110 and a UART 131. The FPGA cells 202, 204, 206 are coupled to the peripheral functions, namely, external bus controller (EBC)107, SDRAM controller 111, a customer-specific or SOC provider proprietary function (e.g., debugger or performance monitor) 109, peripheral controller 122, I²C interface 124 and the second UART 126, the DMA controller 128, the MAL function 164 and the plurality of MACs 129a-129d. Each of these FPGA cells 202, 204, 206 and 208 can be individually and independently configured to give access to one or more of the following functions.

The listed functions that can be enabled by the FPGA cells are representative of the functions that could be enabled using the FPGA cells but is not an exhaustive list. One of ordinary skill in the art readily recognizes that a FPGA cell could be used to enable functions other than those shown in FIG. 1.

The functions described in the FPGA cell will exist on every SOC but can be selectively enabled on an application or customer-specific basis in a number of ways. The individual FPGA cells are personalized after POR and set the enable bits according to the personalization information in its companion ROM. Bit 0 in the Enable Status Register will be set by the FPGA to indicate that it has completed all required macro connections and register updates. In addition to setting the bits in the register the FPGA personalization will also complete actual physical connections required to connect the peripheral function to the base. If a hacker from attempts to override the enable bit by redirecting the processor software to monitor a register whose bits can be set in software (and falsely indicate that a function should be accessible), the peripheral function will still not be accessible because it will not be physically connected to the base.

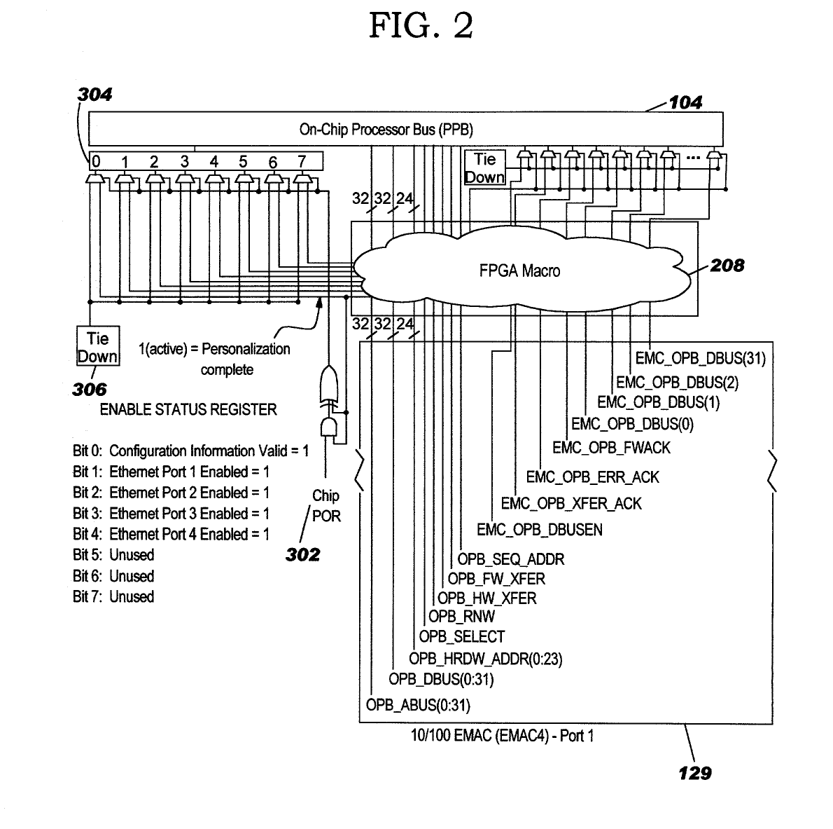

FIG. 2 describes how a portion of the logic for FIG. 1 (Enable one or more Ethernet ports) could be implemented utilizing an FPGA cell. In this scenario, an FPGA cell 208 is coupled between one or more Ethernet MAC 129 and the on-chip functions that communicate with the MAC 129, specifically the memory access layer (MAL) (not shown) and the on-chip peripheral bus (OPB) 104. The MAC 129 communicates to the OPB 104 via a defined set of interface signals. The Ethernet/OPB interface signals defined in the MAC 129 are shown as inputs to and outputs from the embedded FPGA cell 208. The FPGA cell 208 can be programmed to complete the connections to the OPB 104 or tie them to an inactive state.

An enable status register 304 is coupled between the bus 104 and the FPGA cell 208. The purpose of the enable register 304 status is to allow the processor a method for determining what peripherals are enabled before attempting to execute functions that require a peripheral, a scenario that would end in unknown states and could hang the processor. The default value in the register 304 is 0 indicating that none of the peripheral functions is enabled. FPGA programming changes the actual function of the circuits in the FPGA cell that cannot be done by software executing on the processor.

In this manner software hackers are prevented from accessing function that was not intended for their use by altering software that runs on the processor. Changes could be made to the FPGA personalization file stored in the ROM but this takes access to specialized FPGA programming software and hardware and engineering skills that are not in way as pervasive as generic programming skills.

In a preferred embodiment, the FPGA cell is personalized from a companion ROM (not shown) as part of the chip. In this embodiment, the power-on reset (POR) signal 302 is held active until the FPGA personalization is complete. When the POR signal (302) is asserted, the O value from the tie down circuit (306) will indicate to the chip logic which of the ports are enabled by setting bits in the Enable Status Register 304 as all 0's. This indicates that no ports are enabled. If the personalization file indicates Ethernet port 1 is enabled, the FPGA logic writes a 1 to bit 1 of the enable status register. If port 2 is enabled, the FPGA logic writes a 1 to bit 2, etc. After all appropriate enablement bits are set, the FPGA cell 208 outputs a 1 to bit 0 of the register(304) indicating that personalization is complete. When POR is complete, the SOC logic will then allow the register to be updated for the processor to query. The personalization/POR sequence described is one example of how the cell could be personalized.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system on a chip (SOC) integrated circuit comprising:
a plurality of logic functions, the plurality of logic functions including a plurality of base functions and a plurality of peripheral functions; and
at least one field programmable gate array (FPGA) cell, coupled to the plurality of peripheral functions, wherein the FPGA cell can be configured to selectively enable the plurality of peripheral functions.

2. The SOC integrated circuit of claim 1 which includes a bus coupled to the at least one FPGA cell.

3. The SOC integrated circuit of claim 2 wherein the FPGA cell can be programmed to complete connections from the bus to the peripheral functions or tie the peripheral functions to an inactive state.

4. The SOC integrated circuit of claim 3 wherein the FPGA cell programs a register coupled thereto.

5. The SOC integrated circuit on a chip of claim 1 wherein a customer can configure the FPGA cell.

6. A system on a chip (SOC) integrated circuit comprising:
a plurality of logic functions, the plurality of logic functions including a plurality of base functions and a plurality of peripheral functions;
a plurality of buses; and
a plurality of field programmable gate array (FPGA) cells, each of the plurality of FPGA cells coupled to a portion of the peripheral functions and to one of the plurality of buses, wherein each of the plurality of FPGA cells can be configured to selectively enable a number of peripheral functions.

7. The SOC integrated circuit of claim 6 wherein the plurality of buses comprises a processor local bus (PLB) and an on-chip peripheral bus (OPB).

8. The SOC integrated circuit of claim 6 wherein the FPGA cell can be programmed to complete connections from the bus to the peripheral functions or tie the peripheral functions to an inactive state.

9. The SOC integrated circuit of claim 8 wherein the FPGA cell programs a register coupled thereto.

10. A SOC integrated circuit on a chip (SOC) integrated circuit comprising:
a plurality of logic functions, the plurality of logic functions including a plurality of base functions and a plurality of peripheral functions;
a plurality of buses, wherein the plurality of buses comprises a processor local bus (PLB) and an on-chip peripheral bus (OPB), and
a plurality of field programmable gate array (FPGA) cells, each of the plurality of FPGA cells coupled to a portion of the peripheral functions and to one of the plurality of buses, wherein each of the plurality of FPGA cells can be configured to selectively enable the portion of peripheral functions, wherein the FPGA cell can be programmed to complete connections from one of the plurality of buses to the peripheral functions or tie the peripheral functions to an inactive state, and wherein the FPGA cell is programmed through a register coupled thereto.

11. The SOC integrated circuit of claim 10 wherein the plurality of base functions comprise any combination of:
a processor, a universal interrupt controller, an SDRAM controller, an on-chip controller (OCM), an SRAM, a PLB arbiter, an OPB arbiter, an OPB bridge, and a UART.

12. The SOC integrated circuit of claim 11 wherein the plurality of peripheral functions comprise any combination of:
an external bus controller (EBC), an SDRAM controller, a proprietary function, a peripheral controller, an I²C interface, and a second UART, a DMA controller, a media access layer (MAL) function, and a plurality of media access controllers (MACs).
